(19) United States
(12) Patent Application Publication
(10) Pub. No.: US 2003/0076616 A1
(43) Pub. Date: Apr. 24, 2003

(54) Method of searching for optimal positioning system compensator using functions of different orders

(76) Inventor: Yi-Ping Hsin, Burnsville, MN (US)

Correspondence Address: Theodore M. Magee, WESTMAN CHAMPLIN & KELLY, Suite 1600 - International Centre, 900 South Second Avenue, Minneapolis, MN, 55402-3319, US

(21) Appl. No.: 10/176,226

(22) Filed: Jun. 20, 2002

Related U.S. Application Data
(63) Continuation-in-part of application No. 10/043,427, filed on Jan. 10, 2002.
(60) Provisional application No. 60/345,111, filed on Oct. 23, 2001.
(60) Provisional application No. 60/364,359, filed on Mar. 14, 2002.

(51) Int. Cl. G11B 5/596; G11B 21/02

(52) U.S. Cl. 360/78.09; 360/75

(57) ABSTRACT

A method is provided for identifying a transfer function used to regulate a response of a positioning system. The method includes identifying data representing a desired frequency response for a transfer function. A first function of one order is generated based on the identified data. A second function of a larger order than the order of the first function is also generated based on the identified data. A transfer function based on one of the first function or second function is then selected and used to regulate the response of the positioning system.

### RELATED APPLICATIONS

This application is a continuation-in-part of a U.S. patent application having Ser. No. 10/043,427, entitled “AUTOMATIC MODEL REGULATION IN A DISC DRIVE SERVO SYSTEM USING MODEL REFERNCE INVERSE”, filed on Jan. 10, 2002, which claimed priority of U.S. provisional application Serial No. 60/345,111, filed Oct. 23, 2001. The present application also claims priority from U.S. provisional application No. 60/364,359 filed Mar. 14, 2002 and entitled “Automatic search of optimal compensator for plant regulation in a disc drive servo system”.

### FIELD OF THE INVENTION

This application relates generally to disc drives and more particularly to automatic model regulation in a servo system.

### BACKGROUND OF THE INVENTION

Disc drives are data storage devices that store digital data in magnetic form on a rotating storage medium on a disc. Modern disc drives comprise one or more rigid discs that are coated with a magnetizable medium and mounted on the hub of a spindle motor for rotation at a constant high speed. Information is stored on the discs in a plurality of concentric circular tracks typically by an array of transducers (“heads”) mounted to a radial actuator for movement of the heads relative to the discs. Each of the concentric tracks is generally divided into a plurality of separately addressable data sectors. The read/write transducer, e.g. a magnetoresistive read/write head, is used to transfer data between a desired track and an external environment. During a write operation, data is written onto the disc track and during a read operation the head senses the data previously written on the disc track and transfers the information to the external environment. Critical to both of these operations is the accurate locating of the head over the center of the desired track.

To locate the head on the track, and in particular, to maintain the head over a desired position within a track, most disc drives use a closed-loop servo positioning system that feeds the current position of the head back to a control unit which attempts to move the head based on the head's current position and a desired position for the head. As is well known in the art, such feedback systems have resonant modes or frequencies at which the gain of the system increases. In disc drives, these resonant modes tend to correlate with the physical resonance of one or more mechanical parts in the positioning system.

To reduce the gain at the resonant modes, equalization filters have been inserted in the servo control loop to attenuate the gain at selected frequencies. In the past, the frequencies at which the attenuation is provided is based on examining a large number of disc drives and identifying the most common resonant modes. Filters for attenuating these modes were then added to the servo loop. Although such filtering helps to reduce some resonant modes, it does not remove all resonant modes in all drives. In other systems of the art, notch filters have been set by identifying the resonant modes associated with each head in a particular drive. Thus, each head will have its own set of notch filters.

Although providing notch filters on a per head basis has improved attenuation of resonant modes, some resonant modes still persist. Thus, further techniques are needed for attenuating these resonant modes. In particular, better techniques are needed for identifying the proper shape of the filter that should be added to the servo loop while insuring that the added filter does not introduce delays that will make the loop unstable.

### SUMMARY OF THE INVENTION

A method is provided for identifying a transfer function used to regulate a response of a positioning system. The method includes identifying data representing a desired frequency response for a transfer function. A first function of one order is generated based on the identified data. A second function of a larger order than the order of the first function is also generated based on the identified data. A transfer function based on one of the first function or second function is then selected and used to regulate the response of the positioning system.

These and various other features as well as advantages which characterize embodiments of the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 illustrates a functional block diagram of what is commonly referred to as the servo loop of the disc drive.

FIG. 3 illustrates a portion of the servo loop shown in FIG. 2.

FIG. 4 is a bode plot showing frequency response of the voice coil motor in a disc drive an embodiment of the present invention.

FIG. 5 is a flow diagram illustrating exemplary steps for identifying a transfer function using functions of different orders.

FIG. 6 is a flow diagram illustrating exemplary operations carried out during disc drive operation employing an equalization filter.

### DETAILED DESCRIPTION

The invention is described in detail below with reference to the drawing figures. When referring to the figures, like structures and elements shown throughout are indicated with like reference numerals.

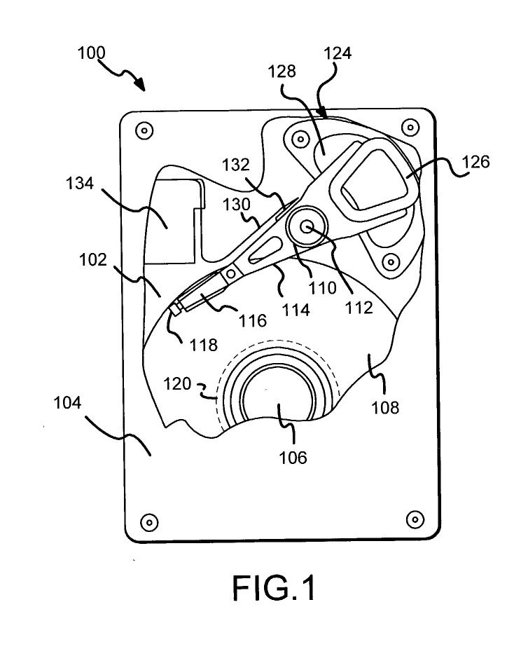

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106, which rotates one or more discs 108. Information is written to and read from tracks on the discs 108 through the use of an actuator assembly 110, which rotates about a bearing shaft assembly 112 positioned adjacent the discs 108. The actuator assembly 110 includes a plurality of actuator arms 114, which extend towards the discs 108, with one or more flexures 116 extending from each of the actuator arms 114. Mounted at the distal end of each of the flexures 116 is a head 118, which includes an air bearing slider, enabling the head 118 to fly in close proximity above the corresponding surface of the associated disc 108.

The actuator assembly is moved by a voice coil motor (VCM) 124 and in some embodiments one or more microactuators (not shown). Voice coil motor 124 includes a coil 126 attached to the actuator assembly 110, as well as one or more permanent magnets 128 that establish a magnetic field in which the coil 126 is immersed. The controlled application of current to coil 126 causes magnetic interaction between permanent magnets 128 and coil 126 so that coil 126 moves in accordance with the well-known Lorentz relationship. As coil 126 moves, the actuator assembly 110 pivots about the bearing shaft assembly 112, thereby moving heads 118 across the surfaces of the discs 108.

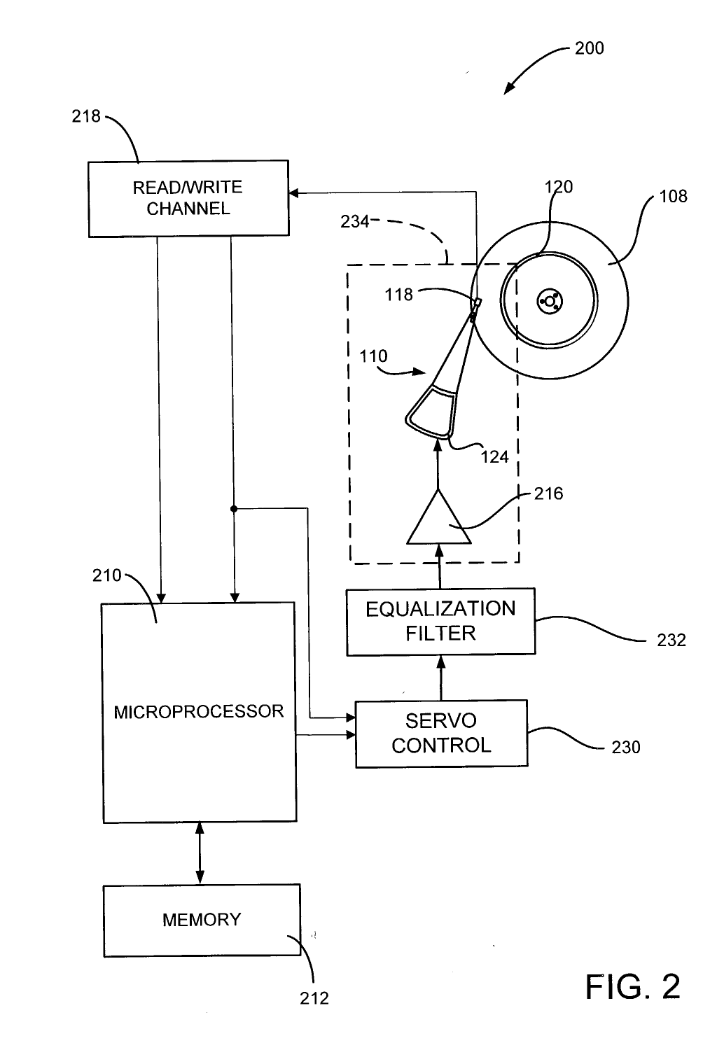

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100. The disc drive 100 further includes a drive controller 210 (FIG. 2), which is operable to be coupled to a host system or another controller that controls a plurality of drives. In an illustrative embodiment, the drive controller 210 is a microprocessor, or digital signal processor.

FIG. 2 illustrates a functional block diagram of a servo system or positioning system 200 of the disc drive 100, employing an embodiment of the present invention. In general, servo system 200 includes a disc drive microprocessor 210 having an associated memory 212, a servo control module 230, an equalization filter 232, a trans-conductance amplifier 216, a VCM plant 234, and a read/write channel 218. The VCM plant 234 generally includes actuator assembly 110, transducer heads 118, trans-conductance amplifier 216, VCM 124, and optionally one or more microactuators. The VCM plant 234 is also referred to as the VCM actuator system. In operation, the microprocessor 210 typically receives a read or write command from a host computer (not shown) that indicates that a particular logical block address is to be accessed. In response, microprocessor 210 translates the logical block address into a physical address representing the track and sector on one or more of the discs that correspond to the logical block address. Microprocessor 210 determines the current position of the heads over the disc and based on that position and the desired position, determines an appropriate velocity or seek profile to use to move the head to its desired position. Based on this seek profile, microprocessor 210 generates a series of desired positions for the head, which are provided to servo control 230.

Servo control 230 subtracts the current position of the head from the desired position received from microprocessor 210 to generate a position error signal (PES). Based on the position error signal, servo control 230 generates an actuator control value that passes through a filter 232 and is converted into an amplified current by a digital-to-analog convertor (not shown) and transconductance amplifier 216. The current from transconductance amplifier 216 is applied to coil 126, thereby generating a magnetic field that causes the actuator assembly to rotate. As head 118 moves, it reads position information stored in servo fields on the disc. In particular, head 118 converts a magnetic pattern representing the position information into an electrical signal. The electrical signal is then demodulated by read/write channel 218 to identify the position information in the signal. This position information can include the track number and the position signal indicating the location of the head within the track. The position information is fed back to servo control 230 thereby forming a servo loop in the servo controller. Based on the newly determined position of the head and the desired position from microprocessor 210, servo control 230 issues a new actuator control value.

Once the head reaches the desired track, the servo loop enters a track following mode in which the servo loop attempts to keep the head at a desired radial position within the track. During the track follow operation, the servo control 230 subtracts the absolute position value provided by read/write channel 218 from the desired track position set by microprocessor 210 to generate the Position Error Signal (PES). This Position Error Signal is then used by servo control 230 to generate an actuator control value that will move the head toward the desired track position. Because of eccentricities in the shape of the track, movement of the disc spindle relative to the actuator assembly, and vibrations and resonances in the actuator assembly, constant adjustments must be made to the actuator value to keep the head in the desired position.

In the embodiment shown in FIG. 2, and other embodiments described herein, the logical operations of the equalization filter 232 and the servo control module 230 may be implemented as a sequence of computer implemented steps or program modules running on a microprocessor, such as, microprocessor 210. It will be understood to those skilled in the art that the equalization filter 232 may also be implemented as interconnected machine logic circuits or circuit modules within a computing system. Additionally, the servo control module may be implemented in a separate component of the disc drive 100, such as a dedicated servo controller. The implementation is a matter of choice dependent on the performance and design requirements of the disc drive 100. As such, it will be understood that the operations, structural devices, acts, and/or modules described herein may be implemented in software, in firmware, in special purpose digital logic, and/or any combination thereof without deviating from the spirit and scope of the present invention as recited within the claims attached hereto. Furthermore, the various software routines or software modules described herein may be implemented by any means as is known in the art. For example, any number of computer programming languages, such as “C”, “C++”, Pascal, FORTRAN, assembly language, Java, etc., may be used. Furthermore, various programming approaches such as procedural, object oriented or artificial intelligence techniques may be employed.

In this embodiment, the computer implemented steps and corresponding digital data that comprise the operations of the equalization filter 232 are stored in some form of computer-readable media. As used herein, the term computer-readable media may be any available media that can be accessed by a processor or component that is executing the functions, steps and/or data of the equalization filter 232. By way of example, and not limitation, computer-readable media might comprise computer storage media and/or communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computer or processor which is executing the operating code. Computer-readable media may also be referred to as computer program product.

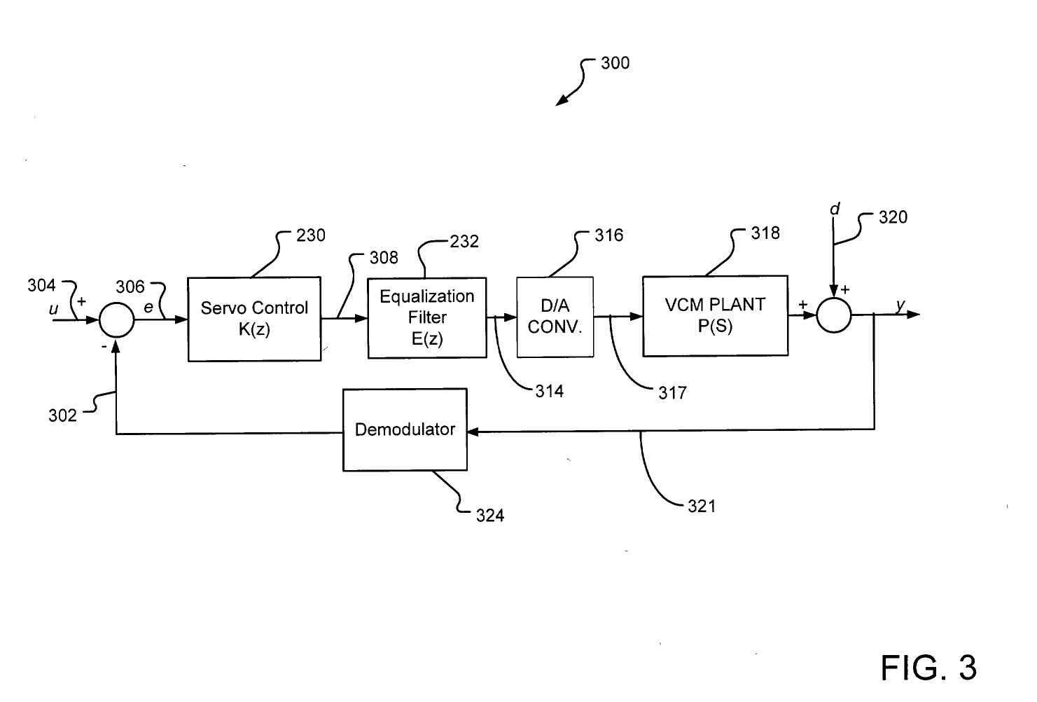

FIG. 3 illustrates an analytical model 300 showing the transfer functions of servo loop 200. The servo control module 230 has a discrete-time domain transfer function K(z). The equalization filter 232 has a discrete-time domain transfer function E(z). The VCM plant has a continuous-time domain transfer function P(s). The natures of the transfer functions K(z), E(z), and P(s) dictate how each of their associated modules will respond to input signals. During operation, a position signal 302 is generated by the demodulator 324. The position signal 302 is negated from a reference signal 304 to obtain the Position Error Signal 306. The PES 306 is applied to servo control transfer function 230 (K(z)) to generate actuator control signal 308. Actuator control signal 308 is applied to equalization filter transfer function 232 (E(z)) to produce a digital input signal 314, which is transmitted to a digital-to-analog convertor that is modeled as a zero order hold transfer function 316. Under this model, the digital-to-analog convertor converts the digital input signal 314 into an analog input signal 317 without introducing a pole or zero into the servo loop. Analog input signal 317 is applied to VCM plant transfer function 318 (P(s)).

The output of VCM plant transfer function 318 is a head position that is shown as being corrupted by a disturbance signal 320 to produce a measured head position 321. Disturbance signal 320 represents disturbances to the output of the VCM transfer function 318 due to disc 108 vibration and wind induced VCM actuator vibration. Measured head position 321 is an analog electrical signal that is converted into a digital position signal 302 by a demodulator 324. Like the digital-to-analog convertor, demodulator 324 is modeled as not introducing a separate transfer function into the servo loop. The position signal 302 is subtracted from reference signal 304 to generate the next PES 306.

Servo control transfer function 230 is designed based on an ideal VCM plant transfer function to minimize the effect of disturbances to the measured head position 321. Generally, the ideal VCM plant model includes one or more fundamental resonance modes that are impractical to remove from the VCM plant. However, as shown in FIG. 3, due to physical limitations and manufacturing tolerances, significant deviations are observed between the ideal and actual VCM plant with respect to resonance characteristics Under the present invention, this problem is overcome by introducing the equalization filter transfer function 232, which is set to compensate for the differences between the ideal VCM plant transfer function and the actual plant transfer function.

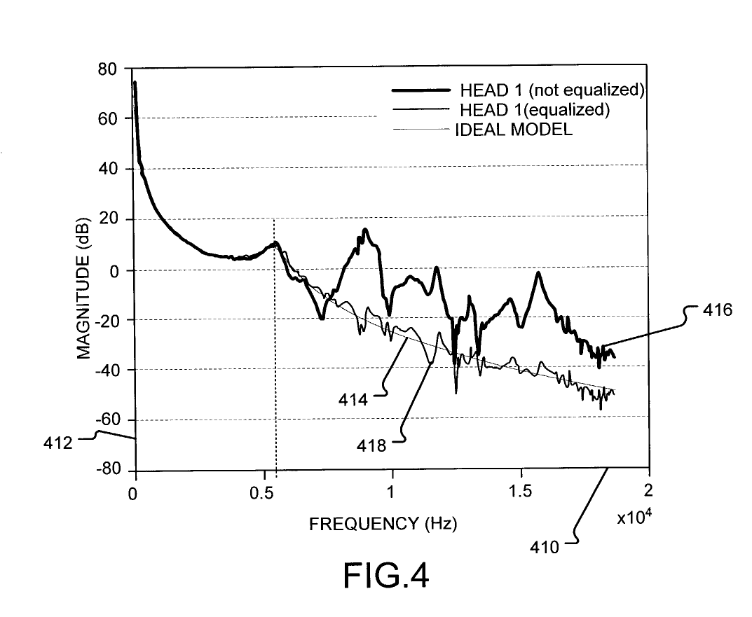

To illustrate the affects of the equalization transfer function, a Bode plot 400 is provided in FIG. 4 showing three frequency responses. For clarity, the phase information has been removed from the Bode plot 400 and the plot is not shown to scale. The x-axis 410 represents frequency, while the y-axis 412 represents the gain in decibels (dB) provided by various transfer functions. Shown in the Bode plot 400 are an ideal frequency response 414 generated by an ideal VCM plant transfer function, a non-equalized frequency response 416 (darker line) generated by an actual VCM plant without equalization, and an equalized frequency response 418 generated by an actual VCM plant with the equalization filter in place. To generate both the non-equalized frequency response 416 and the equalized frequency response 418, a chirp signal is added to the actuator control value generated by the servo control. The digital input signal 317 and the position signal 302 are then measured to determine the frequency response of the VCM plant. As can be seen in FIG. 4, equalized response 418 more closely tracks ideal response 414 than does non-equalized response 416.

Various methods of implementing an equalization filter 232 may be used with respect to this embodiment. The equalization filter 232 may be mathematically represented in the general form:

$${E}_{m} ( z ) = \frac{\tilde{P} ( z )}{{P}_{m} ( z )} , \qquad EQ . ( 1 )$$

where Eₘ(z) is the transfer function for the equalization filter 232 for the m^{th} head, Pₘ(z) is the discrete-time domain transfer function for the m^{th} head of the actual VCM plant 234, \tilde{P}(z) is a discrete-time domain ideal transfer function for an ideal VCM plant, and m is a head number. Equation (1) represents Em(z) being determined by computing a relative difference between the actual VCM plant response, Pₘ(z), and an ideal VCM plant response, \tilde{P}(z). By implementing the relative difference in the equalization filter 232, the equalization filter 232 will compensate for unwanted characteristics in the response of the VCM plant 234. As a result, the feedback response input to the servo control module 230 will be closer to the response for which the servo control 230 was designed. Using equation (1), a separate equalization filter 232 may be generated for each of m heads in the disc drive 100.

Occasionally, frequencies of resonance modes will vary for a particular head from one zone to another as the head moves radially over the surface of the disc. A zone, as used in this context means any range of tracks, and does not necessarily refer to the recording zones of the disc. Thus, it is envisioned that more than one equalization filter may be developed and stored for each head of the disc drive. To do so, a transfer function Pₘᵢ(z) can be determined for each of ‘i’ zones in which a recording head ‘m’ may be positioned. An equalization transfer function Eₘᵢ(z) may then be developed for each of the ‘i’ zones for each of the ‘m’ heads.

In one embodiment, the discrete-time domain transfer function Eₘ(z) is implemented using a state-space implementation. A state-space implementation is described in U.S. Pat. No. 6,101,058 issued to John C. Morris, entitled “Method of Implementing a Linear Discrete-Time State-Space Servo Control System on a Fixed-Point Digital Signal Processor in a Disc Drive,” which is hereby incorporated for all that it teaches and discloses. Those skilled in the art will readily recognize how to implement the function Em(z) using the teachings of U.S. Pat. No. 6,101,058.

Under embodiments of the present invention, an equalization transfer function is determined for each head by fitting compensator frequency data to a number of different equalization transfer functions, each of a different order. The different ordered transfer functions are each reduced to a common order that the disc drive can manage. The frequency response associated with each order-reduced transfer function is then determined along with the frequency response of the plant with the equalization transfer function in place. One of the transfer functions is then selected based on a set of criteria. By fitting the compensator frequency data to transfer functions of different orders, the present invention is able to achieve a better fit than if the transfer functions were limited to a single order.

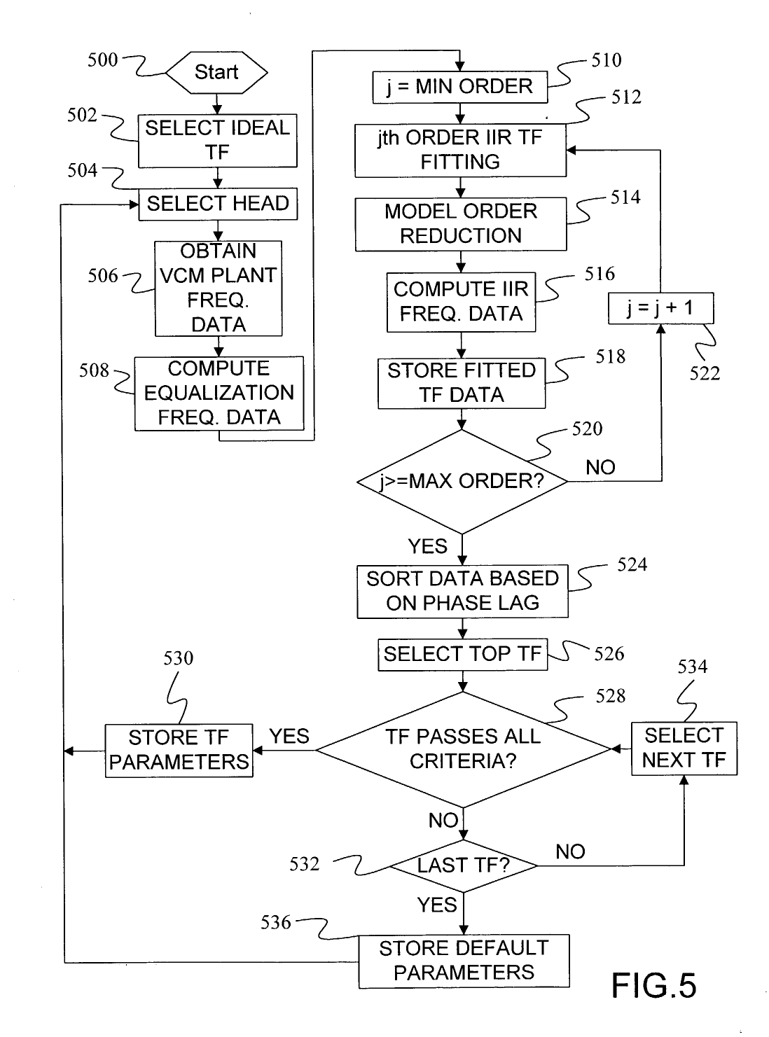

FIG. 5 provides a flow diagram of a method for identifying equalization transfer functions for heads in a disc drive under embodiments of the present invention. The method starts at step 500 and proceeds to step 502 where an ideal transfer function, \tilde{P}(z), for the VCM plant is selected. The ideal VCM plant model is preferably an analytical transfer function that exhibits an optimal frequency response. Under one embodiment, the ideal plant transfer function P (z) is given with the general formula:

$$\tilde{P} ( z ) = Z \{ \tilde{P} ( s ) \} , and \\ \tilde{P} ( s ) = {ⅇ}^{- s \tilde{T}} \frac{\tilde{K}}{{s}^{2}} \frac{{\tilde{w}}^{2}}{{s}^{2} + 2 \tilde{ξ} \tilde{w} s + {\tilde{w}}^{2}} \qquad EQ . ( 2 )$$

where Z{•} denotes the bilinear or direct pole-zero mapping Z-transform, and \tilde{K} and \tilde{T} are desired DC gain and computational/electronics delay, respectively. The values \tilde{ζ} and \tilde{w} are the desired damping ratio and the desired natural frequency, respectively.

The ideal transfer function shown in equation (2) may be viewed as characterizing that portion of the structural dynamics in the VCM plant of the disc drive 100 that does not vary significantly from part to part. In other words, it may be viewed as a transfer function for a rigid body system having one or more fundamental resonance modes, for which the servo control module 230 is designed. One skilled in the art will readily recognize how an ideal transfer function can be derived. By way of example, and not limitation, the transfer function in equation (2) may be determined by testing a small population of disc drives that are known to exhibit a substantially ideal response, and that are substantially static in their response. After gathering a desired number of data points that characterize the response of the substantially ideal transfer function, the data points may be fitted to a curve. Computer software known in the art may then be run on a computer to derive the analytical expression for \tilde{P}(z) shown in equation (2).

In one implementation, the ideal plant model is universal for all heads in the disc drive plant. In other words, the response characterized by the ideal model is the response that the designer desires the heads to exhibit. Thus, the ideal model depends on the design and criteria to be optimized. Software programs exist in the art that can be used to select and develop the ideal model. The software programs can generate analytical constants that characterize the transfer function for the ideal model. Those constants are stored in memory in the disc drive to be used later in regulating the plant transfer function. The ideal model is selected and developed either before manufacture of the disc drive or experimentally during the manufacture of the disc drive.

After the ideal model has been selected and constants have been stored in memory, a head is selected at step 504 and frequency data is collected using the selected head at step 506 to determine the actual frequency response of the VCM plant. Under many embodiments, the frequency data is collected by introducing sinusoidal signals at a number of different frequencies and measuring the response at each frequency as described above. For example, the sinusoid signals may range in frequency from 100 Hz to half of the disc drive sampling frequency, located at 10 Hz increments.

At step 508, the response at each frequency is divided by the value of the ideal transfer function at the respective frequency to generate a set of desired response values for the equalization filter. These values are stored for later use.

Once the equalization filter data has been stored, it can be used to identify possible equalization transfer functions. Under embodiments of the present invention, equalization transfer functions of different orders are fit to the data and the transfer function that provides the least phase lag and meets a set of criteria is selected. This process begins at step 510, where the minimum order for the transfer functions is selected. In many embodiments, the minimum order is twelve. At step 512, an equalization transfer function of the minimum order is identified from the stored equalization data. Under most embodiments, the equalization transfer function is identified by finding an analytical function that best describes the data through curve fitting. Software algorithms are available and readily apparent to those skilled in the art for fitting a curve. Under most embodiments, the transfer function is first identified as a fraction wherein the numerator and denominator each contain a polynomial.

After fitting step 512, the order of the equalization transfer function is reduced at step 514. This reduction step is used because computational limitations of most disc drives constrain the order of the transfer function that the disc drive can managed. Under one embodiment, the equalization transfer function is limited to a twelfth order function.

To perform the order reduction, one embodiment of the present invention converts the polynomial representation of the equalization transfer function into an input-output balanced state-space model, reduces the order in state space, and converts the reduced model to a polynomial representation. Techniques for converting a polynomial representation of a transfer function to and from a state-space representation are well known and software algorithms for performing the conversion are available. For instance, MATLAB from The MathWorks, Inc. of Natick, Mass. provides tools for making such conversions.

The state-space representation of the equalization transfer function takes the form of:

x(k+1)=Ax(k)+Bu(k)

y(k)=Cx(k)+Du(k) EQ.(3)

where x(k) is a vector of states at time k, x(k+1) is a vector of states at time k+1, u(k) is the value of signal input to the transfer function at time k, y(k) is the value of the output provided by the transfer function at time k, and A, B, C, and D are parameter matrices that describe the state system. The number of states in the vector of states is equal to the initial order of the equalization transfer function.

To reduce the order of the state-space representation of the transfer function, the vector of states is divided into a matrix containing a vector having a number of states equal to the desired order and a vector having a number of states equal to the initial order minus the desired order. Thus, the state vectors become:

$$\begin{matrix}x ( k ) = [ \begin{matrix}{x}_{1} ( k ) \\ {x}_{2} ( k )\end{matrix} ] & EQ . ( 4 ) \\ x ( k + 1 ) = [ \begin{matrix}{x}_{1} ( k + 1 ) \\ {x}_{2} ( k + 1 )\end{matrix} ] & EQ . ( 5 )\end{matrix}$$

where x₁(k) and x₁(k+1) are the state vectors representing the reduced order transfer function and x₂ (k) and X₂ (k+1) are the state vectors for the orders of the transfer function that are to be discarded.

Using these definitions, and dividing the parameter matrices A, B, and C based on the division to the state vector, equation 3 above becomes:

$$[ \begin{matrix}{x}_{1} ( k + 1 ) \\ {x}_{2} ( k + 1 )\end{matrix} ] = [ \begin{matrix}{A}_{11} & {A}_{12} \\ {A}_{21} & {A}_{22}\end{matrix} ] [ \begin{matrix}{x}_{1} ( k ) \\ {x}_{2} ( k )\end{matrix} ] + [ \begin{matrix}{B}_{1} \\ {B}_{2}\end{matrix} ] u ( k ) \\ y ( k ) = [ {C}_{1} {C}_{2} ] [ \begin{matrix}{x}_{1} ( k ) \\ {x}_{2} ( k )\end{matrix} ] + Du ( k ) \qquad EQ . ( 6 )$$

The states for the orders that are to be discarded are then treated as being static such that:

x₂(k+1)=x₂(k) EQ.(7)

Substituting this relationship into equation 6 results in the reduced-order model:

x₁(k+1)=[A₁₁+A₁₂(I−A₂₂)⁻¹A₂₁]x₁(k)+[B₁+A₁₂(I−A₂₂)⁻¹B₂]u(k)

y(k)=[C₁+C₂(I−A₂₂)⁻¹A₂₁]x₁(k)+[D+C₂(I−A₂₂)⁻¹B₂]u(k) EQ.(8)

This reduced order model is then converted from state space to a polynomial transfer function. The polynomial transfer function is then used at step 516 to calculate the response of the transfer function at a set of frequencies as well as the equalized response of the VCM plant at a set of frequencies, where the equalized response represents the combination of the response of the equalization transfer function and the actual VCM plant response. This data is stored at step 518.

At step 520, the order used to form the current equalization transfer function is compared to a maximum order that will be considered. Under one embodiment, the maximum order is forty. If the current order is less than the maximum, the order is increased by one at step 522 and the process returns to step 512 where the frequency data found in step 508 is fit to a transfer function of the new order. After steps 512, 514, 516 and 518 have been performed for a transfer function of each order between the minimum order and the maximum order, the process continues at step 524 where the resulting transfer functions are sorted based on their phase lag.

The phase lag for a transfer function is determined from the reduced-order transfer function determined in step 514. In particular, the phase lag is determined as the ratio of the phase angle of the reduced-order transfer function over the frequency associated with the phase angle. This ratio is the slope of a plot of the phase angle versus frequency. A smaller phase lag is preferable over a larger phase lag since the phase lag represents the delay introduced by the equalization filter. This delay should be minimized to maintain stability of the servo loop.

After the equalization transfer functions for the various orders have been sorted, the top-most transfer function (the one with the lowest phase lag) is selected at step 526. The frequency data for this transfer function is retrieved and examined to determine if it meets a set of criteria set for the transfer function. These criteria can include whether the equalization transfer function or the equalized plant transfer function have an amplitude below a particular value for a given frequency, whether the equalization transfer function or the equalized plant transfer function have a variation within a frequency range that is below a particular value, or whether the equalized plant transfer function deviates from the ideal plant transfer function by more than a set amount. For example, under one embodiment the criteria include:

1. The equalization transfer function at frequencies below 10 kHz having an amplitude of less than 6 dB.

2. The equalization transfer function at 8 kHz having an amplitude of less than −2 dB3.

The equalization transfer function having an amplitude variation below 3 kHz of less than 3 dB.

4. The equalized plant transfer function at frequencies above 9 kHz having an amplitude of less than −10 dB.

5. The equalized plant transfer function deviating from the ideal plant transfer function at all frequencies by less than 3 dB.

If the first selected equalization transfer function meets the selected criteria at step 528, it is selected as the equalization transfer function for the current head and its parameters are stored at step 530. These parameters are later retrieved to set the equalization filter used during positioning operations that involve the selected head.

If the current equalization transfer function does not pass all of the criteria at step 528, the process continues at step 532 where the list of transfer functions is examined to determine if there are additional equalization transfer functions to be considered. If there are more transfer functions, the next transfer function in the sorted list is selected at step 534. The frequency data for the newly selected equalization transfer function is then retrieved to determine if the equalization transfer function meets all of the criteria at step 528.

Steps 528, 532, and 534 continue until an equalization transfer function is found that meets all of the criteria or there are no more transfer functions to consider at step 532. If there are no more transfer functions to consider at step 532, none of the computed equalization transfer functions meet the criteria. As a result, a default equalization transfer function is selected at step 536.

After step 536 or step 530, an equalization transfer function has been identified for the current head. The process continues at step 504, where the next head in the drive is selected. The remaining steps of the method are then repeated for the newly selected head.

Under many embodiments, the method of FIG. 5 is performed for each disc drive during production. In addition, the calculations performed in FIG. 5 can be performed by an external processor, which receives the frequency data for the actual VCM plant from the disc drive and stores the best identified equalization transfer function for each head in the disc drive.

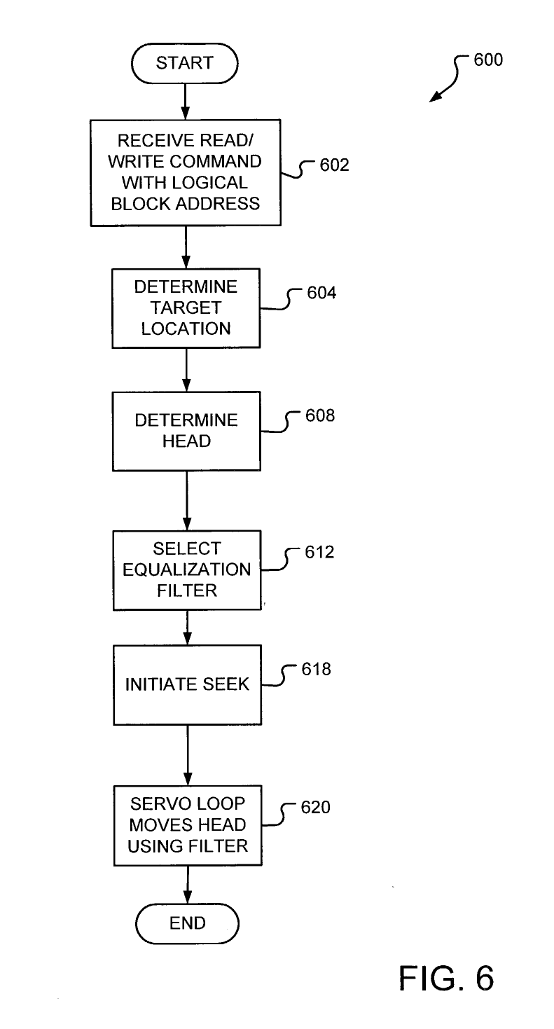

FIG. 6 is a flow diagram 600 illustrating exemplary method steps employed during the operation of the disc drive 100 to position a transducer head 118 utilizing an equalization filter 232 of the present invention. The process begins at step 602 where microprocessor 210 receives a read or write command from the host. The read/write command includes a logical address that describes the location for the read or write operation. At step 604, microprocessor 210 converts the logical block address into a target position on a disc in the disc stack. Based on which disc the target is located on, microprocessor 210 then selects a head at step 608. The parameters of the equalization transfer function or equivalently the parameters of the equalization filter that is capable of providing the equalization transfer function are then retrieved at step 612 based on the head selected at step 608. These parameters are used to define equalization filter 232. Once the equalization filter has been set, microprocessor 210 begins a seek operation at step 618 by generating a desired position signal 304. In response, the servo loop moves the head at step 620 until the head reaches the target based on the position signal and maintains the head in that position until the position signal changes. Thus, the equalization filter 232 is used during both the seek operation and the track following operation.

The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts, steps, or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

In summary, a method is provided for identifying a transfer function used to regulate a response of a positioning system (such as 200). The method includes identifying data representing a desired frequency response for a transfer function (such as at 508). A first function of an order is generated (such as at 512) based on the identified data. A second function of a larger order than the order of the first function is also generated (such as at 512 after 522) based on the identified data. A transfer function based on one of the first function or second function is then selected (such as at 524, 526, 528, 532, 534, 530) and used to regulate the response of the positioning system (such as at 612).

In another embodiment, a method of setting filter parameters for a filter (such as 232) in a servo control system (such as 200) is provided. Under the method, a plurality of functions, each of a different order, are created (such as at step 512) by attempting to match each function to a same set of desired frequency values. The order of at least one of the plurality of functions is reduced (such as at 514) to form a plurality of transfer functions, each of the same order. One of the transfer functions is selected (such as at 524, 526, 528, 530, 532, 534). The selected transfer function is the used to set the filter parameters (such as at 612).

In a third embodiment, a method of manufacturing a disc drive (such as 100) is provided. Under the method, a set of desired frequency characteristics is used to form at least two functions (such as at 512) each of a different order. A separate transfer function is formed from each of the at least two functions (such as at 514). One of the transfer functions is selected (such as at 524, 526, 528, 530, 532, 534) and is used to set parameters for a filter (such as 232) in the disc drive (such as 100).

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the equalization filter could be employed in other (non-disc drive) environments where mechanical resonance modes arise and reduce performance of servo control. Additionally, analog versions of the equalization filter may be suitable for analog environments and may be readily apparent to those skilled in the art. Numerous other changes may be made which will readily suggest themselves to those skilled in the art and which are encompassed in the spirit of the invention disclosed and as defined in the appended claims.

What is claimed is:

1. A method of identifying a transfer function used to regulate a response of a positioning system, the method comprising steps of:
(a) identifying data representing a desired frequency response for a transfer function;
(b) generating a first function of an order based on the identified data;
(c) generating a second function that is of a larger order than the order of the first function based on the identified data;
(d) selecting one of a transfer function that is based on the first function and a transfer function that is based on the second function as the transfer function used to regulate the response of the positioning system.

2. The method of claim 1 wherein generating a first function comprises fitting a first function to the identified data.

3. The method of claim 2 wherein generating a second function comprises fitting a second function to the identified data.

4. The method of claim 1 further comprising reducing the order of the second function to produce a reduced-order function.

5. The method of claim 4 wherein selecting one of a transfer function that is based on the first function and a transfer function that is based on the second function comprises selecting the reduced-order function.

6. The method of claim 4 wherein reducing the order of the second function comprises:
converting the second function from a polynomial representation to a state-space representation;
reducing the order of the second function in state-space to produce a state-space representation of the reduced-order function; and
converting the state-space representation of the reduced-order function to a polynomial representation of the reduced-order function.

7. The method of claim 1 wherein selecting one of a transfer function that is based on the first function and a transfer function that is based on the second function comprises sequentially testing the transfer functions to determine if they satisfy a set of criteria.

8. The method of claim 7 wherein sequentially testing the transfer functions comprises ordering the transfer functions based on the phase lags of the transfer functions and testing the transfer functions based on that ordering.

9. The method of claim 1 further comprising:
reducing the order of the first function to produce a first reduced-order function; and
reducing the order of the second function to produce a second reduced-order function, the first reduced-order function and the second reduced-order function being of the same order.

10. The method of claim 1 wherein the positioning system forms part of a disc drive having multiple heads and steps a-d are repeated for each head.

11. A disc drive formed through the method of claim 1.

12. A method of setting filter parameters for a filter in a servo control system, the method comprising steps of:
(a) creating a plurality of functions, each of a different order, wherein each function is created by attempting to match each function to a same set of desired frequency response values;
(b) reducing the order of at least one of the plurality of functions to form a plurality of transfer functions, each of the same order;
(c) selecting one of the transfer functions; and
(d) using the selected transfer function to set the filter parameters.

13. The method of claim 12 wherein reducing the order of a function comprises:
converting the function from a polynomial representation to a state-space representation;
reducing the order of the state-space representation; and
converting the state-space representation into a polynomial representation of the transfer function.

14. The method of claim 12 wherein selecting one of the transfer functions comprises:
determining the phase lag of each transfer function; and
using the phase lags of the transfer functions to select one of the transfer functions.

15. The method of claim 14 wherein using the phase lags of the transfer functions to select one of the transfer functions comprises:
determining that the transfer function with the smallest phase lag meets a set of criteria; and
selecting the transfer function with the smallest phase lag as the transfer function.

16. The method of claim 14 wherein using the phase lags of the transfer functions to select one of the transfer functions comprises:
determining that a transfer function with the smallest phase lag does not meet a set of criteria;
determining that a transfer function with the second smallest phase lag meets a set of criteria; and
selecting the transfer function with the second smallest phase lag as the transfer function.

17. The method of claim 12 wherein the set of desired frequency response values is determined based on an ideal transfer function for a portion of the servo control system and a set of actual frequency response values the portion of the servo control system.

18. The method of claim 12 wherein the servo control system forms part of a disc drive.

19. A disc drive formed through the method of claim 18.

20. An apparatus having a filter wherein the parameters of the filter are determined through steps comprising:
(a) using a set of desired frequency characteristics to form at least two functions, each of a different order;
(b) forming a separate transfer function with each of the at least two functions;
(c) selecting one of the transfer functions; and
(d) using the selected transfer function to set parameters for the filter.
